(19) United States
(12) Patent Application Publication
(10) Pub. No.: US 2015/0195392 A1
(43) Pub. Date: Jul. 9, 2015

(54) WEARABLE CELL PHONE HOLDER VIEWER AND MOBILE COMPUTER SYSTEM

(71) Applicant: Israel Nissenbaum, Brooklyn, NY (US)

(72) Inventor: Israel Nissenbaum, Brooklyn, NY (US)

(21) Appl. No.: 14/147,033

(22) Filed: Jan. 3, 2014

(51) Int. Cl. H04M 1/04

(52) U.S. Cl. CPC H04M 1/04

(57) ABSTRACT

A wearable cell phone holder enabling stable, hands-free viewing of cell phone screen while the cell phone is supported on the viewer's torso and a method by which a cell phone is utilizable for computer functions. The wearable cell phone holder comprises a rigid flat base element to which a short stand element is attached such as by vacuum attachment. The stand element has an adjustably positioned clamp for holding the cell phone in a wearer viewable position. A lanyard is attached to a proximal side of the base element to support the clamped cell phone by the viewer's neck with the base element resting on the viewer's torso. An adjustable anchoring belt anchors the distal side of the base element against movement during viewing use of the cell phone. The hands-free held cell phone is usable with a Bluetooth connected keyboard for use as a computer.

### FIELD OF THE INVENTION

This invention relates to holders for smart cell phones, “phablets”, or small tablets, which holders enable the viewing of the cell phones and the use thereof as highly mobile computers. In particular it relates to holders which are wearable, and which hold the phones or tablets adjacent a viewer's eyes in a hands-free manner, for the clear viewing of text, while the viewer is sitting, standing or even walking.

### BACKGROUND

Holders for cell phones or small tablets have, as far as is known, not been configured to enable a cell phone to be wearably viewable by being supported adjacent a viewer's eyes in a hands-free manner (the term “cell phone” as used herein, includes “cell phones”, larger cell phones known as “phablets” and small tablets, generally with up to 7″ diagonal screens with minimal bezel width and general hand holding width of under 5″). Viewable cell phone holders have instead, for the most part, been confined to desktop stands, leg supports, lap desks, free standing supports and the like. Simple, wearable carrying of the cells phones has been for non-viewable transport purposes only, such as with cell phone case holders being clipped on to belts or with the cell phones being enclosed in cases having straps, which are simply draped around the neck.

It is believed that the wearable use of cell phones, in a manner similar to sheet music holders for marching bands, has, at least in part, been generally precluded by the fact that the cell phones and small tablets are generally heavier than sheet music and are more liable to hill. Cell phones require difficult to provide greater support, especially since the use thereof often involves touch screen manipulation and pressing, which exacerbates toppling or dislodgement pressure. In addition, as a further complication for wearable cell phone holders configured for viewing purposes, cell phones also require some distancing from a viewer's face and eyes by at least a focal length for comfortable viewing. This is markedly different from that of a harmonica held by a harmonica holder (to enable multi-instrument use), which is required to be positioned very close to a player's mouth. As a result, cell phone holders similar to that of harmonica holders would normally have needed to have greater extensions, with concomitant greater leverage and increased likelihood of instability and of inadvertently falling. Since cell phones, with glass screens and enclosed electronics are generally much more fragile and expensive than sheet music and harmonicas, holders therefor would therefore have required extensive anchoring, in order to provide minimization of possible toppling and falling. Hands-free camera supports illustrate such extensive anchoring, and usually involve complicated full body harness configurations which are not readily positioned or removed and are highly confining and are used almost entirely by professional photographers or skilled amateurs.

Some large tablet holders have been configured for being worn to provide the large tablet (9 to 10″ diagonals or more) in an ersatz desk configuration generally parallel to the ground, while distanced from the wearer, to provide room for hand manipulation and control of the tablet. This is however not a viable expedient with small screen cell phones which cannot be readily or clearly seen at such a distance and generally require a positioning at no further than about chest level, for the comfortable reading of on-screen text. For such purposes cell phones are invariably used by hand holding of the device or with support of the cell phone on a distanced desk, table and the like.

Other holders of cell phones, though not capable of allowing cell phone viewing, have been made in recognition of the audio characteristics of cell phones. Some cell phone holders have been configured for the proximate very close holding of the actual small cell phones (instead of a Bluetooth device) adjacent a user's ear.

Some cell phone holders have been configured for attachment to the upper thigh of a user for use while sitting but which expedient is not suitable for use while standing or walking and is in any event too distanced for comfortable viewing of text. Other types of holders abound including free-standing supports for viewing and use while lying or sitting and the like. However, at least partly, because of the perceived necessity of providing manual access to the touch screen of a smart cell phone, and stability issues, hands-free wearable holders for cell phones are not generally available for use in holding cell phones in proximity with a user's eyes for the simple viewing of the screens thereof.

Simple viewing of television shows, movies. YouTube clips, on-line or downloaded video courses and the like, on a smart cell phone usually requires extended periods of tiring hand holding of the cell phone. Alternatively, such viewing requires the supporting use of a desk or other support means, which may not always be available (e.g., while riding in a train, bus or subway). Furthermore, positioning of the cell phone or small tablet on a desk of other support does not provide for comfortable use, from a viewing standpoint, because of the limited size of the cell phone screens of only up to about 7″ diagonal screen size and the viewing distances involved. With the advent of more powerful cell phones with larger screens and word processing programs and the like, use of a separable keyboard such as a Bluetooth keyboard, therewith is also very awkward, if at all possible, without hands-free support of the cell phone.

### SUMMARY OF THE INVENTION

It is accordingly an object of the present invention to provide a stable, viewer-adjustable, economical, uncomplicated, easily positioned and removable, comfortable, wearable support for cell phones, to enable the screens thereof to be clearly viewed in portrait or landscape mode, as desired, including small character text, without hand use for support or holding of the cell phone, but while permitting stable manual touch screen manipulation.

It is a further object of the present invention to provide such wearable holder with a rapid donning and removal configuration, with stabilization against accidental removal or falling of the cell phone and with pivoting vertical and horizontal adjustment including pivoting adjustment between portrait and landscape viewing positions and for viewer adjustment of viewing angle for comfortable use.

It is still another object of the present invention to provide a method and device which enable the transformation of a smart cell phone, with computer capability, to be used as such for mobile functions such as word processing, spread sheet preparation and analysis, slide presentations, private video viewing with audio capability, private on line meetings and conversations of Webex and Skype type and the like.

It is yet another object of the present invention wherein the wearable holder is also optionally configured as a stable desk or table stand for the cell phone without or with only minimal modification from being wearable.

Generally the present invention comprises a body supported cell phone holder device configured to enable the stable hands-free viewing of the screen of the cell phone while being supported on the viewer's torso of either or both chest or stomach. The invention further comprises a method by which a cell phone is utilizable with the body supported cell phone holder device for computer functions such as word processing, on-line meetings. Skype type audio/visual conversation and the like without a desk and in conjunction with a separate data or control input device such as a Bluetooth connected keyboard.

The wearable cell phone holder device comprises:
i) a torso-supported rigid base element configured for being supported by the viewer's torso (defined as encompassing the areas of a viewer's chest and/or stomach above the waist).
ii) a short stand element with a cell phone engaging and gripping member which is configured to enable the cell phone to be viewably adjustable and a member configured for integrating or securely attaching the short stand element to the base element at a preferably centered position of the base element.
iii) an adjustable neck and/or shoulder engaging element configured to be attached to a proximal (relative to the wearer's neck) side of the base element and attached stand with gripped cell phone, for the hands-free support of the base element and cell phone. Less preferably, the engaging element is configured to be also or alternatively attached to a viewer's torso, provided slippage and comfort problems are addressed, and
iv) an optional anchoring element configured to securely engage a more distal side of the base element and attached stand, to anchor the base element against unwanted movement thereof relative to the viewer's torso, with fixation anchoring of the anchoring element to or with at least one of the viewer's body and clothing.

The method of using a cell phone as a wearable computer by a wearing viewer comprises the steps of:
a) supporting a cell phone by means of a wearable cell holder device in a hand-free manner on the viewer's body, and viewably close to a viewer's eyes, for a viewer to comfortably, proximately, operably view the cell phone screen as a computer screen,
b) providing operational means for adjusting any or all of the viewing distance, the viewing angle, the horizontal/vertical landscape and the portrait mode while the cell phone holder device is worn in a viewing position;
c) connecting the cell phone to a separate data input or control device, and preferably a Bluetooth connected keyboard;
d) optionally anchoring the cell phone holder with the viewer's body or clothing to reduce or prevent positional movement; and
e) optionally connecting the viewer's ear or ears such as with ear buds to the audio output of the cell phone to enable private listening and/or with a microphone input to permit on-line audio/visual mobile meetings of Webex type or audio/visual telephone conversations of Skype type.

The proximately positioned cell phone screen, in conjunction with an input device such as a Bluetooth connected keyboard, is able to effect computer functions such as word processing, preparation of spread sheets and slide presentations and the like with the keyboard being operated by the viewer's hands. In addition, current computer functions of on-line meetings or audio/visual telephone conversations may be effected, with greater privacy because of the close proximity of viewing screen to the viewer's eyes, even while the attendee or converser is walking or riding (but not driving) in an internet accessible area. It is of course understood that such uses should only be effected in situations where distraction is not detrimental or where there is a safe awareness of environmental conditions.

Preferably the cell phone holder comprises a short, arced, stand element with one end comprising the cell phone-gripping member and having a pivoting connection, such as a ball joint and socket configuration. The phone gripping member is preferably a spring loaded padded clamp which is openable to at least 3″ and is thereby readily adjustable to tightly hold nearly all currently available cell phones across their respective widths. Alternatively, other holding means are utilizable such as bezel engaging snap fittings at the sides or corners of the cell phones, though such holders may entail closer dimensional requirements or customization of holder to specific cell phone dimensions.

A base of the gripping member is preferably connected to a vertical support portion of the stand with the ball joint and is configured to provide a pivoting connection therewith. Pivoting movement of the pivoting connection is preferably enabled to provide landscape viewing or horizontal positioning to a portrait or vertical position viewing of the gripped cell phone. The horizontal-vertical pivoting should be enabled for at least 90° of rotation and preferably a full 360° of rotation to permit upright screen viewing of the cell phone of an upright screen image in all directions (cell phones almost invariably include automatic vertical/horizontal adjustment of the screen).

Pivoting of the cell phone is also enabled with the ball joint to provide a backward and forward (relative to the viewer) rotation movement sufficient to permit the viewer to make personal adjustments to provide comfortable viewing of the small screen while compensating for the viewer's torso body structure (e.g., stomach or breasts).

For stability, the short stand element should preferably be less than about 3″ and preferably no more than about 5″, from the bottom of the base to pivoting element, in order to minimize any lever effect of a longer stand which may provide instability resulting in toppling or moving of the cell phone out of viewing position. The retained cell phone is also positioned at a comfortable yet proximate screen viewing distance from a user's eyes for the reading of text. Such screen viewing distance is preferably about 8-15″ though it will of course vary according to screen size, text size, and resolution as well as personal preferences and viewing ability and eyesight. Because of the relatively small screen sizes of cell phones, viewing distances of tabletops and laps, as used with notebook computers, are not operationally viable for normal computer use with the cell phones.

The short stand element is fixedly or separably connected in place, with a supporting base configured and dimensioned for resting on a user's chest or stomach (depending on the viewer's body structure and height) to provide positional stability and for connection to body anchoring or supporting elements. Generally, a rigid 5″×5″ square supporting base is sufficient to provide the requisite stability for the stand element and the retained cell phone. The shape of the base and the dimensions are however not limiting in this regard, with the requirement being that the base provide sufficient stable support for the stand element with supported cell phone while on a wearer's torso. In a preferred embodiment, the short stand element and supporting base are readily separable for compact carrying. A vacuum or suction connection between a base of the short stand element and a smooth, flat, preferably rigid plastic material of the supporting base, such as an acrylic commonly known by the trademark Lucite provides the requisite strong connection. With such configuration, the cell phone is viewably stably positioned close to and slightly offset from the center of gravity of the attachment of the stand element to the base element. Other separable connecting elements include locking bayonet mounts and spring loaded key in groove configuration. In such latter configuration, a lateral or axial extension is provided at the base of the stand, which extension fits into a corresponding slot of the supporting base. The stand is turned to cause the lateral extension to fit into a position locking groove on the underside of the supporting base with the cell phone gripper being properly positioned thereby. Alternatively, the stand may be collapsible to a minimum size for transport and extended and rigidified when used.

The supporting base is connected or engaged, preferably releasably, with either a rigid or hanging lanyard type neck or shoulder supporting or holding element (e.g. double ended lanyard which is adjustable in length for personal maximum viewing comfort. The supporting base with the short stand and cell phone held thereon is vertically positioned in a viewing position by gravity or cantilevered support by the lanyard or other neck or shoulder support and buttressed by the viewer's torso (chest and/or stomach). Right and left lateral apertures in the upper end (proximal to the viewer's head) of the supporting base are preferably used for engagement with the double-ended lanyard.

For increased stability, particularly if the cell phone touch screen is manually manipulated, it is preferred that the supporting base be additionally supported at its distal end by a anchoring element, which engages and anchors the supporting base to the viewer's torso or clothing such as by encirclement with a belt, band, bungee cord or anchoring straps to belt loops or with alligator clips to the wearer's clothing and the like to provide additional support. Alternatively, the supporting base may include right and left apertures at a distal end thereof for engagement with hook elements or the like of the belt, band or bungee cord or anchoring straps. The base element may also include an upward distally positioned extension which serves to prevent slippage of an encircling anchoring element off the base element.

Less preferably because of comfort and reduced ease in positioning, though still encompassed herein, the lanyard or neck of shoulder supporting element may be replaced with a body or clothing supporting anchoring element for the proximal side of the base such as used with the distal side of the base provided that any slippage issues not present with lanyards or shoulder supports, are accounted for.

If the short stand element is separably connected to the supporting base, it is further optionally preferred that a secondary connection element such as a ring positioned around the short stand in conjunction with short guy-wire type elements, which extend from the ring to the proximate and distal apertures, be used to provide a fail-safe prevention of the cell phone falling or being disengaged from the holder. This secondary connection may supportingly hold both the short stand and the supporting base together. This optionally provides an additional connection between the stand and the base, to prevent falling off of the retained cell phone, should the primary connection between stand and base, such as the suction connection, fail.

The above objects and other objects, features and advantages of the present invention will become more evident from the following discussion and illustrative drawings in which:

### SHORT DESCRIPTION OF THE DRAWINGS

FIG. 1 depicts the separated components of the cell phone holding device of the present invention with a cell phone and an associated Bluetooth keyboard device;

FIG. 1A shows the stand element separated from the gripping element to show the ball joint connection.

FIG. 2 is a front view of the assembled device elements of FIG. 1 just prior to engagement of the cell phone therewith;

FIG. 3 is a left side view of the cell phone holding device of FIG. 2, with retained cell phone;

FIG. 4 is a front view of the cell phone holding device with a cell phone retained in a vertical portrait viewing position;

FIG. 5 is the cell phone holding device of FIG. 4 with the cell phone rotated and held in a horizontal landscape;

FIG. 6A is a viewing position of the cell phone from a wearer's perspective and FIG. 6B is a front view thereof from an observer's perspective both of which show use of the cell phone with a Bluetooth connected keyboard and FIG. 6C is a side view of the arrangement shown in FIG. 61B;

FIG. 7 shows the elements of the cell holding device as disconnected and arranged into a compact space suitable for carrying in a pocket or purse;

FIG. 8 shows the cell phone holding device as a tabletop cell phone holder; and

FIG. 9 shows the alternative anchoring elements of two pairs of clothing straps with clip ends.

### DETAILED DESCRIPTION OF THE INVENTION

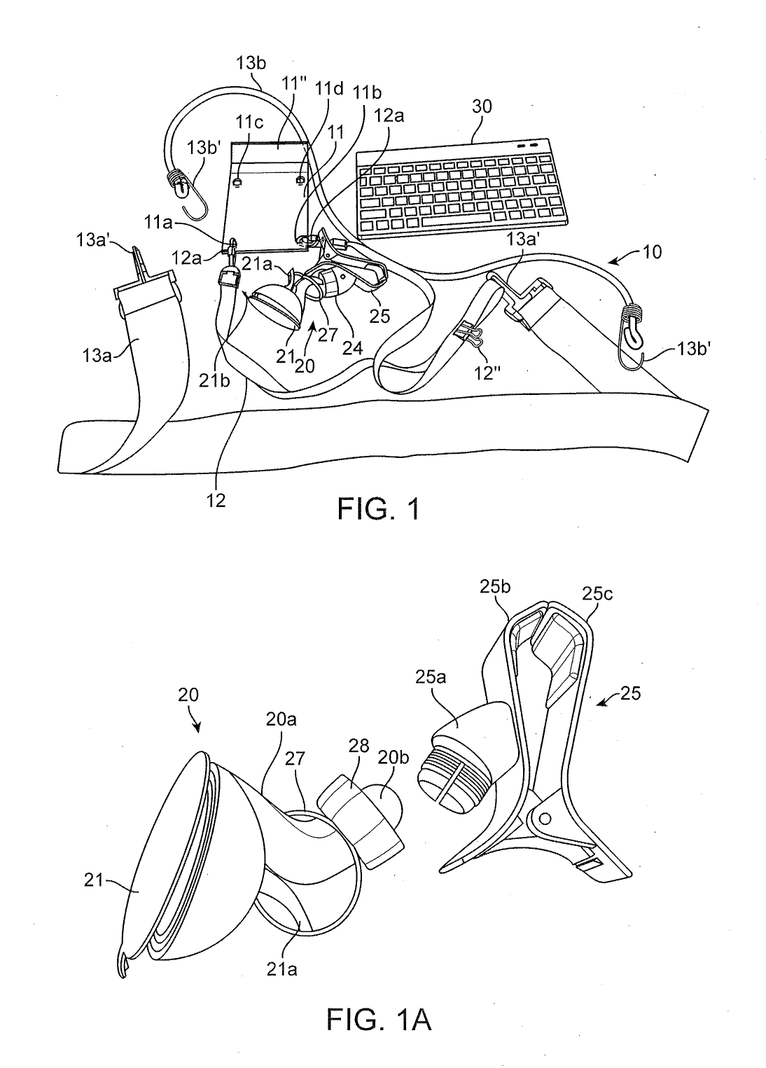

With reference to the drawings. FIG. 1 shows the separated component parts of the cell phone holder 10 of flat rigid supporting base 11 of acrylic plastic; arced stand 20 with cell phone spring loaded gripping clamp 25 attached at one end of the stand via a ball joint connection 24 and a vacuum suction connection 21 at another end of the stand; adjustable neck-engaging double ended lanyard 12; and alternative optional adjustable anchoring elements of: belt 13a, elastic bungee cord 13b, and straps with clothing clips 13c (shown in FIG. 9).

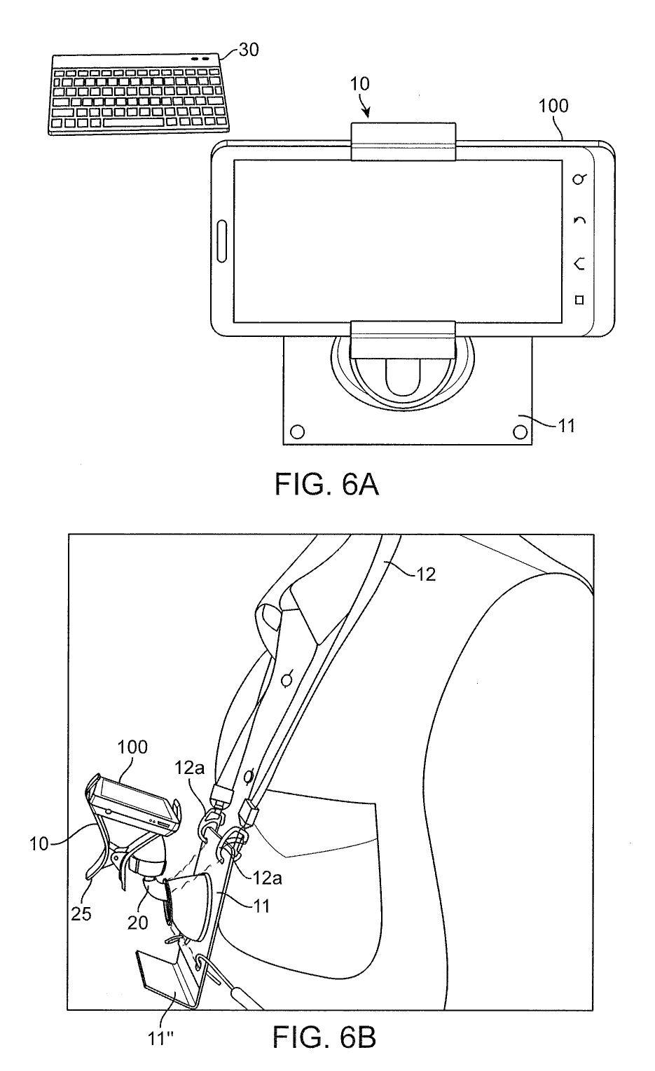

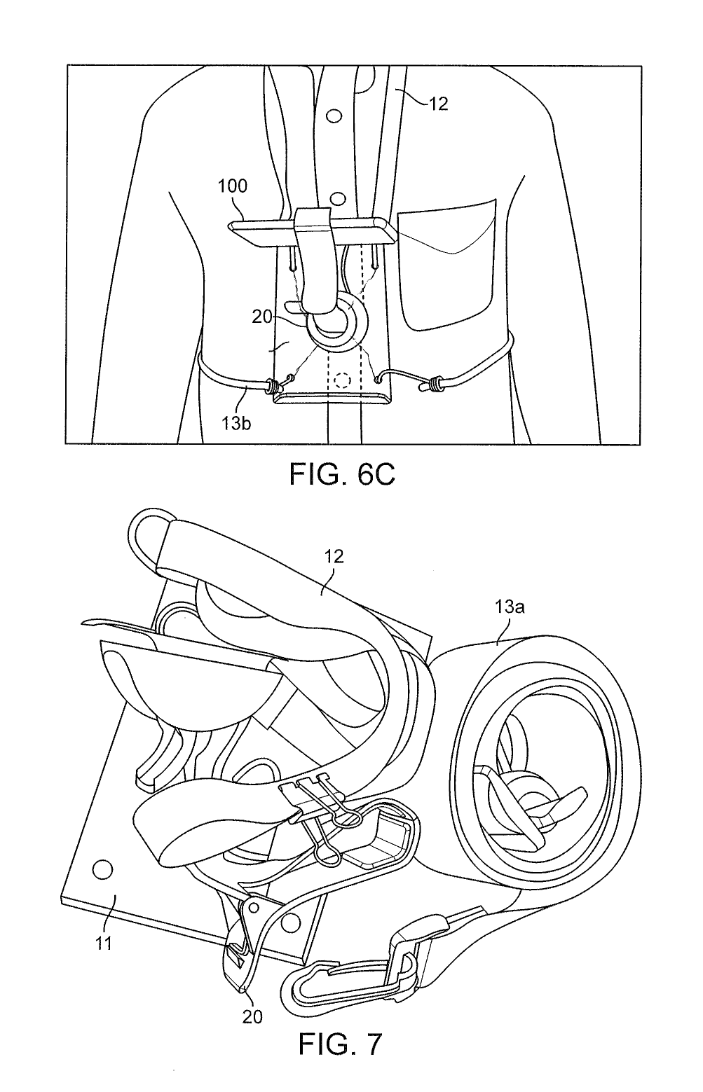

FIG. 1A shows the arced stand 20 separated into base stand 20a with terminal ball 20b and gripping clamp 25 with ball engaging end 25a with separated externally threaded spreadable teeth elements 25b which engage ball 20b with a movable ball joint configuration. Threaded collar 28 holds the elements together by threaded engagement with the threaded teeth elements 25b. Bluetooth connected keyboard 30, shown with the component parts 10 is not part of the cell phone holder device, but is utilizable with the cell phone 100, when worn as shown in FIGS. 6A-C.

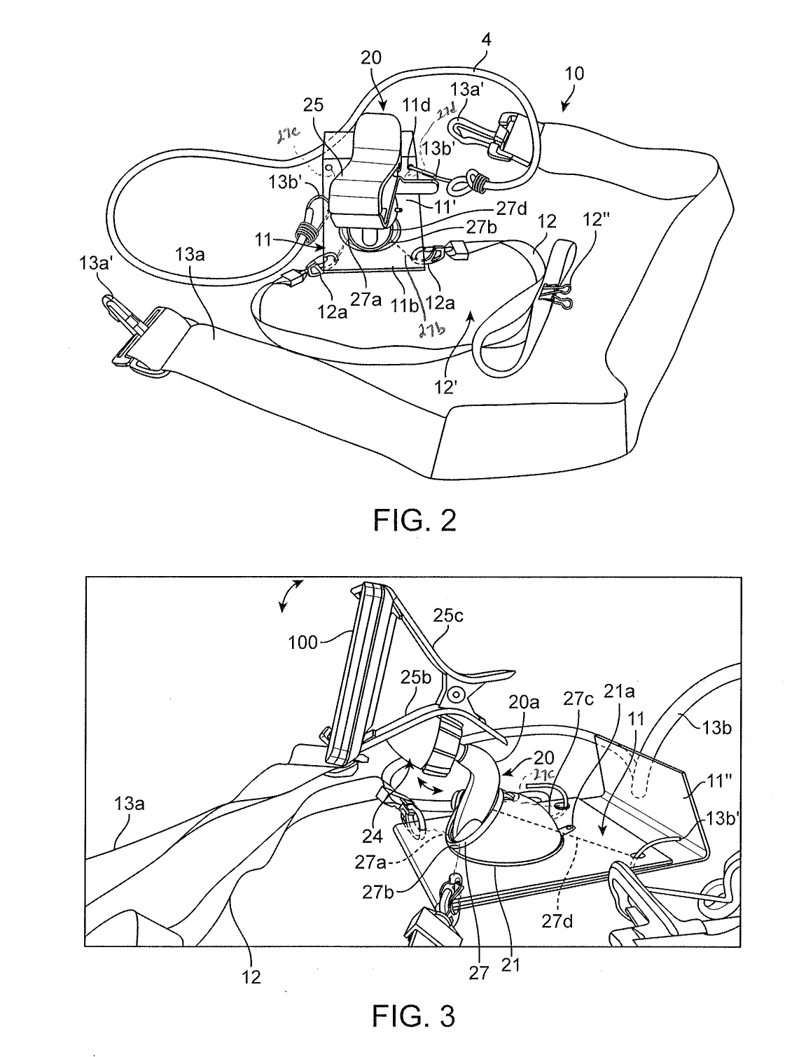

As seen in assembled device 10 of FIG. 2, arced stand 20 is attached to the center of surface 11′ of supporting base 11 via vacuum suction attachment 21 with vacuum clamp 21a (shown in FIGS. 1 and 1A). Arced stand 20 is positioned such that cell phone gripping clamp 25 faces the proximal end of base 11 with apertures 11a and 11b to which lanyard 12 is attached with removable clips 12a. Lanyard 12 thereby forms a loop 12′ for draping on a viewers neck, as seen in FIGS. 6B and 6C, for support of the supporting base with gripped cell phone 100, as buttressed against the viewer's torso. Length adjusting element 12″ provides length adjustment of the lanyard 12 for personal adjustment of the distance from a viewer's eyes to the viewed cell phone 100. Though the lanyard support may be sufficient, in conjunction with the buttressing of the supporting base against the viewer's torso for non-interactive viewing or without movement of the viewer, it is preferred that an adjustable anchoring element such as bungee cord 13b, straps with clothing clips 13c (shown in FIG. 9) or adjustable belt 13a be used to anchor the distal end of base 11 against movement. As shown in FIG. 2, bungee cord 13b, elastically adjusts to encircle a wearer's torso and is hooked to base 11 at apertures 11c and 11d with hooks 13b′ or to each other. Adjustable belt 13a is similarly attached to the base 11 by clips 13a′ being engaged with apertures 11c and 11d respectively. The belt 13a or bungee cord 13b, as shown in FIGS. 6B and 6C snugly encircles the viewer's body to provide the anchoring support and is readily emplaced and removed with the engagement/disengagement of one of clips 13a′ or 13b′. Alternatively, the encirclement is effected by direct engagement between respective end clips 13a′ or 13b′ with the bungee cord 13b or belt 13a being positioned directly on surface 11′ of base 11 at a position distal to the vacuum suction attachment 21. The wider belt 13a may also cover part of the vacuum suction element to provide a reinforcement against dislodgement of the supporting arced stand 20.

FIG. 3 shows the spring loaded padded jaws 25b and 25c of cell phone gripping clamp 25 as being separated, with a cell phone 100 being clamped therebetween. Because of the spring loading of the clamp and the clamping distance D between the jaws 25b and 25c of at least 3″ when fully extended, the clamp can effectively tightly hold most smart cell phones, with larger width phones being slidingly engaged from the side between fully extended jaws. The arced arrows in FIG. 3 indicate the back and forth adjustment direction on the ball joint 24 once the cell phone is emplaced for personal viewer preferences of the best angle for viewing and for compensation of viewer body shape.

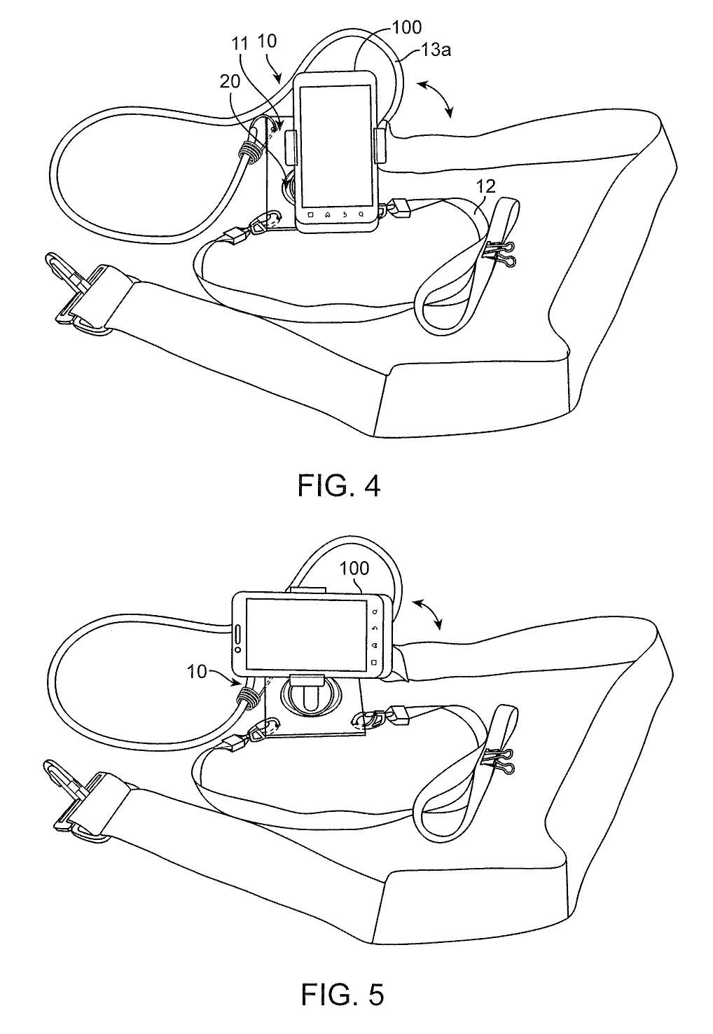

FIG. 4 depicts a front view of the cell phone 100 as held for viewing by the cell phone holder 10, with the cell phone positioned in a vertical or portrait viewing position. FIG. 5 depicts the same view but with the cell phone 100 rotated 90° into a horizontal landscape position with arrows in both FIGS. 4 and 5 showing the rotation direction. Ball joint connection 24 between the clamp 25 holding the cell phone, and stand section 20a, permits the rapid vertical/horizontal adjustment in-situ without necessity of cell phone removal and re-positioning for optimum viewing of the cell phone screen with the cell phone invariably having a gravitational activation for the vertical/horizontal appropriate positioning.

FIGS. 6a, 6b and 6c show various viewpoints of a wearer with hands-free viewing of a cell phone screen as a monitor, with the use of a Bluetooth connected wireless keyboard 30. The cell phone 100 is held by clamp 25 of cell phone holder 10, with the base 11 thereof being supported on the wearer's torso. Lanyard 12, connected to the base 11 with clips 12a provides a gravitational vertical support for the gripped cell phone with the lanyard 12 remaining clipped to base 11 even with wearing removal of the cell phone holder. Alternative anchor elements of an adjustable belt 13a, elastic bungee cord 13b and short adjustable straps with clothing clips 13c respectively (bungee cord 13b is shown as being used in the Figures), provide alternative axial anchoring of the base 11 against the wearer's torso or clothing to effectively eliminate or minimize any positional movement of the cell phone 100 even when the touch screen thereof is manipulated. Connection of any of the anchoring elements 13a. 13b or 13c, as shown, is either by engagement of retaining clips with the apertures 11c and 11d in base 11, or by interconnection of the clips at the two ends of the adjustable strap or bungee cord to form a hold down strap on the surface 11′ of base 11 with the slippage thereof from such surface being prevented by retaining upright 11″ integrated with the base 11.

The cell phone holder is simply positioned and anchored and conversely removed by looping or unlooping the lanyard over the wearer's head and the clipping or unclipping of anchoring element 13a, 13b or 13c from the base 11 (straps with clothing clips 13c also requiring unclipping from the wearer's clothing).

Ring element 27 positioned around short stand 20 optionally provides additional fail-safe support against vacuum connection disengagement of the stand 20 with gripped cell phone from base 11, by means of guy wires 27a-d (shown in dotted lines) looped around the ring and through apertures 11a-d with cross pins pressed against the bottom of base 11.

The cell phone holder 10 is readily broken down into a minimal size for expedited carrying, with the suction connection 21 being broken by release of vacuum clamp 21a and lifting of tab 21b, with the stand 11 being separated (if desired) from gripping element 25 by release of threaded nut ball joint retainer 25a and removal of the ball joint 24 from prongs 25a The lanyard 12 and the anchoring element 13a, 13b and 13c are coiled (belt 13a is shown) to provide the minimally sized package shown in FIG. 7 or as separate pieces, of a dimension suitable for carrying in a pocket or purse for easy transport and availability.

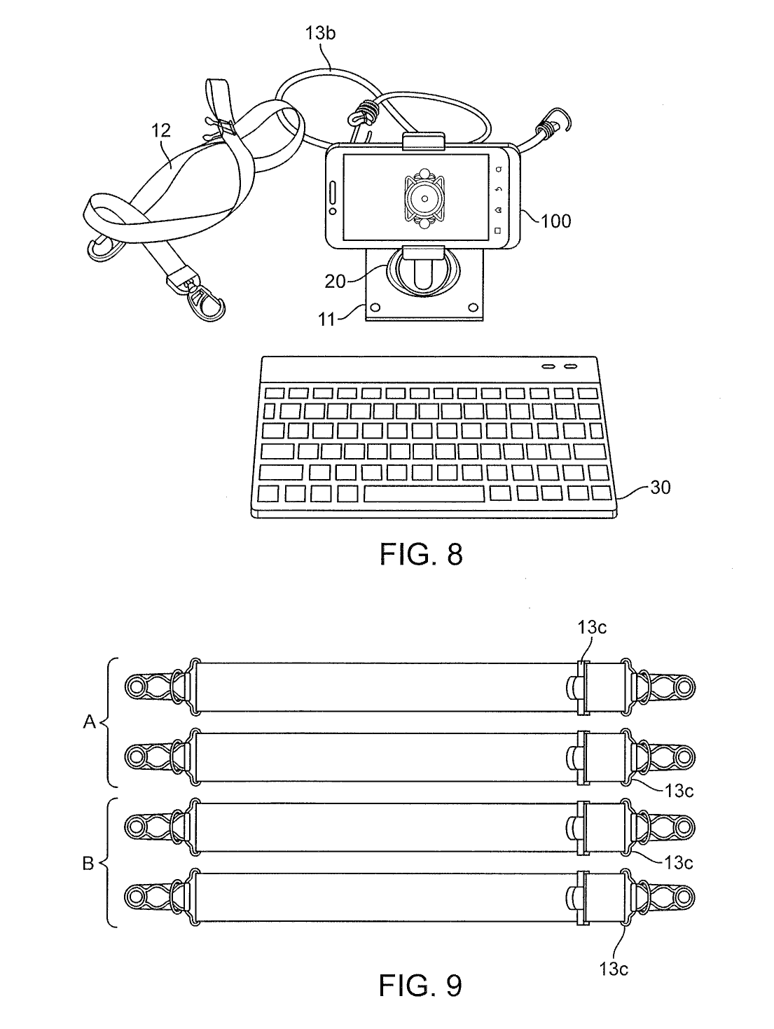

As shown in FIG. 8, the cell phone holder 10 with removal (or even without removal as shown in FIGS. 3, 4 and 5) of lanyard 12 and anchoring element 13a, b or c, may be utilized as an adjustable tabletop or desktop stand as well, with the base 11 providing the requisite support in such utilization embodiment.

FIG. 9 separately depicts two pairs A and B of double ended clothing clips 13c used as alternative anchoring elements in either single or double pairs to hold the cell phone holder base 11 in position against movement by anchoring fastening clipping to a viewer's clothing.

It is understood that the above description and drawings are only illustrative of the present invention with changes in structure such as with connection means between the stand and the base, gripping means for holding the cell phone, materials, types of anchoring elements and the like as well as methods of deployment and use are possible without departing from the scope of the present invention, as defined in the following claims.

1. A wearable cell phone holder device which is compact and configured for wearable hands-free holding of a cell phone by a wearing viewer thereof, the cell phone holding device comprising:
i) a torso-supported rigid base element configured for being stably supported by a torso of the wearing viewer,
ii) a short stand element with:
a. a cell phone engaging and gripping member which is configured to grip the cell phone in a position wherein a screen of the cell phone having alternative landscape and portrait viewing positions is proximal to and operatively viewable by eyes of the wearing viewer with the gripping member being configured to be adjustable in position to enable a screen of a cell phone gripped thereby and without removal therefrom to be viewably adjustable, including to either of the landscape or portrait viewing positions, and
b. a member configured for one of integrating and securely attaching the short stand element to the base element with a cantilevered engagement, wherein the short stand element is of fixed length and height from a base of the short stand to the gripping member thereof whereby the cell phone is gripped at a fixed height from the base element when the screen of the cell phone is positioned to be operatively viewable by the wearing viewer, and
iii) an engaging element configured to be supported and held by a neck of the wearing viewer and attached to the base element with attached stand, and gripped cell phone, for hands-free support of the base element and cell phone, on the torso of the wearing viewer.

2. The wearable cell phone holder of claim 1, further comprising an anchoring element configured to securely engage a more distal side of the base element and attached stand and gripped cell phone, to anchor the base element against unwanted movement thereof relative to the torso of the wearing viewer, with fixation anchoring of the anchoring element to at least one of the neck, a shoulder, the torso and clothing of the wearing viewer.

3. The wearable cell phone holder of claim 1, wherein the engaging element is a double ended adjustable length lanyard with terminal clips and wherein the base element has two apertures formed therein on a side thereof and configured and positioned to be proximal to eyes of the wearing viewer whereby the terminal clips of the double ended lanyard are configured to each engage a respective aperture to hold the base element thereby with the formation of a loop which is configured to be draped over the neck of the wearing viewer's to provide the hands-free support of the base element and gripped cell phone on the torso of the wearing viewer.

4. The wearable cell phone holder of claim 2, wherein the fixed height of the short stand element is up to about five inches from a base of the short stand to the gripping member thereof when the screen of the cell phone is positioned to be operatively viewable by the wearing viewer.

5. The wearable cell phone holder of claim 3, wherein the base of the short stand member comprises a vacuum suction element configured to provide a vacuum suction engagement with an upper surface of the base element with a stable holding connection being formed thereby.

6. The wearable cell phone holder of claim 4, wherein the gripping member comprises a spring loaded clamp configured to holdingly engage opposite sides of the width of the cell phone.

7. The wearable cell phone holder of claim 5, wherein the gripping member is affixed to the short stand member with a ball joint connection which is configured to permit rotation of the gripped cell phone to and from a viewable horizontal landscape position of the cell phone screen and a viewable vertical portrait position, while the cell phone holder with gripped cell phone is being worn without removal of the cell phone from the cell phone holder and wherein the ball joint connection is further configured to permit an angular rotation of the gripped cell phone toward and away from the eyes of the viewer to provide the viewable adjustment of the cell phone screen.

8. The wearable cell phone holder of claim 6, wherein a distal side of the base element is configured to be anchored to the torso of the wearing viewer, to minimize movement of the base element and gripped cell phone, with an adjustable length anchoring element which is attached to the distal side of the base element and is configured to be adjustable to either snugly encircle the torso of the wearing viewer or to be clipped to clothing of the wearing viewer, to provide the distal side anchoring of the base element.

9. The wearable cell phone holder of claim 8, wherein the anchoring element is at least one of an adjustable belt, elastic bungee cord, and straps with clothing clips and elements, for engagement with the base element.

10. The wearable cell phone holder of claim 7, wherein the short stand with gripped cell phone is provided with elements to retain the cell phone from falling in the event of failure of the vacuum connection.

11. The wearable cell phone holder of claim 8, wherein cell phone holder is configured to be separated into component parts of base element, lanyard, anchoring element, short stand and gripping member for the compact storage thereof and carrying in a pocket or purse.

12-15. (canceled)

16. A wearable cell phone holder device configured for wearable hands-free holding of a cell phone by a wearing viewer thereof, the cell phone holding device comprising:
i) a torso-supported rigid base element configured for being stably supported by a torso of the wearing viewer,
ii) a short stand element with:
a. a cell phone engaging and gripping member which is configured to grip the cell phone in a position wherein a screen of the cell phone is proximal to and operatively viewable by eyes of the wearing viewer with the gripping member being configured to be adjustable in position to enable a screen of a cell phone gripped thereby to be viewably adjustable, and wherein the height of the short stand element is up to about five inches from a base of the short stand to the gripping member thereof when the screen of the cell phone is positioned to be operatively viewable by the wearing viewer,
b. a member configured for one of integrating and securely attaching the short stand element to the base element with a cantilevered engagement, wherein the short stand element is of fixed length and height from a base of the short stand to the gripping member whereby the cell phone is gripped at a fixed height from the base element when the screen of the cell phone is positioned to be operatively viewable by the wearing viewer, and
iii) an engaging element configured to be supported and held by at least one of-a neck of the wearing viewer, shoulders of the wearing viewer, the torso of the wearing viewer and clothing of the wearing viewer, and attached to the base element with attached stand, and gripped cell phone, for hands-free support of the base element and cell phone, on the torso of the wearing viewer.

17. The wearable cell phone holder of claim 16, wherein the cell phone engaging and gripping member is configured to grip the cell phone in a position wherein a screen of the cell phone having alternative landscape and portrait viewing positions is proximal to and operatively viewable by eyes of the wearing viewer with the gripping member being configured to be adjustable in position without removal of the cell phone from the cell phone holder to enable a screen of a cell phone gripped thereby to be viewably adjustable, including to either of the landscape or portrait viewing positions.
